(19) United States
(12) Patent Application Publication
(10) Pub. No.: US 2006/0112331 A1
(43) Pub. Date: May 25, 2006

(54) System for supporting to develop an application, and data format producing method and data processing system using said supporting system

(76) Inventors: Hitoshi Ashida, Kawasaki (JP); Masashi Tsuchida, Machida (JP); Naoko Taniguchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/196,753

(22) Filed: Aug. 4, 2005

(30) Foreign Application Priority Data
Nov. 22, 2004 (JP) 2004-337548

(51) Int. Cl. G06F 17/21; G06F 3/00

(52) U.S. Cl. 715/523; 715/700; 715/513

(57) ABSTRACT

For achieving improvements on efficiency of designing and/or development of the data format for use of input/output screens, as well as, on efficiency of development of a reception program for achieving the format transformation, in an application having input/output screen, a system for supporting to develop an application, according to the present invention, has a definition module of data format transformation for producing an entry data format from a business data format. Also, according to the present invention, there is provided a data processing system, applying a definition of data format transformation with data entry screen ID, which has a format transformation module for achieving the format transformation defined for each entry screen, upon a format transformation call of a reception module.

### BACKGROUND OF THE INVENTION

The present invention relates to a system for supporting to develop an application, i.e., as being a designing technology of a computer system accompanying an entry (or input) screen of data, and a method thereof (i.e., a data format producing method and a data processing system, as being an application technology of such the computer system as was mentioned above.

In recent years, the way of thinking, i.e., “MVC” is widely acknowledged or accepted, as being a designing technology for Web applications. Herein, “M” is an abbreviation of “Model”, and it indicates data model. “V” is an abbreviation of “View”, and it indicates a screen. And, “C” is an abbreviation of “Control”, and it indicates a control of screen transition.

It is said that the MVC improves efficiency on developments and maintenances, if designing and developing the “Models” and the “Views”, separately. For example, in designing the screens, the development thereof can be made, if applying GUI based design tools therein, but without necessity of knowledge about programming; therefore, it is possible to leave jobs in relation to the screen designing to a person in charge, who is abundant with business knowledge rather than the knowledge of programming.

However, when data model comes to be large and complicated, it is difficult for the screen designer to understand the model; therefore, there is necessity of designing data for use of the screen, and also data for use of model. As a result of this, it is necessary for a designer or a developer of the models, to design and/or develop data formats for use of screens, and also transformation program between the data for use of screens and the data for use of models.

Accordingly, as one of the problems when improving the efficiency of the application development, it is to design and/or develop the data formats for use of screens, as well as, the transformation program between two (2) data formats, one for use of screens and the other for use of models.

In the following Patent Document 1, it is described that a transformation table is produced when transforming the format, by selecting and linking an element in relation thereto, while displaying a standard format and also a local format on the same screen (Conventional Art 1).

Also, in recent years, attentions are paid upon XML (extensible Markup Language), as being languages for describing the format of data.

About an outline of the said XML, description is made on pages 2-3 and 16-19 of “XML handbook” by Mr. Tatsuo WATANABE (SOFT BANK publishing, Jan. 30, 2001), for example.

And also, there is a specification, XSLT (eXtensible Stylesheet Language), deeply relating to the XML. About an outline of the said XSLT, description is made on page 97 and 101-111 of “XML handbook” by Mr. Tatsuo WATANABE (SOFT BANK publishing, Jan. 30, 2001), for example.

Patent Document 1: Japanese Patent Laying-Open No. Hei 10-307881 (1998), and

Non-Patent Document 1: “XML handbook” by Mr. Tatsuo WATANABE (SOFT BANK publishing, Jan. 30, 2001), pages 2-3, 16-19, 97, and 101-111.

### BRIEF SUMMARY OF THE INVENTION

Thus, in the developments and the maintenances of an application having an input (entry)/output screen, it is one of the problems to design and/or develop the data formats for use of screens, and also, the transformation program between two (2) data formats, one for use of screens and the other for use of models.

In relation to the format transforming method and a definition method thereof, as was mentioned in the conventional art 1, there is already known a method of defining the transformation , between the formats with using the GUI, in the technical field of EDI (Electrical Data Interchange).

However, with such the conventional art 1, it is assumed that those two (2) formats are given, in advance. Accordingly, if applying the conventional technology when developing an application having the input (entry)/output screen, it is possible to produce the data for models from the data for screens, but impossible to design the data for screens.

According to the present invention, a first object is to provide a system and a method enabling to produce the data formats for use of screens from the data formats for use of models, easily.

Also, according to the present invention, a second object is to provide a system and a method, for achieving improvements upon the development of data reception program and the maintenance efficiency, with using common program for all of the screens, as the data reception program for transforming the data for screens into the data for models.

For accomplishing the object mentioned above, according to the present invention, there are provided a system for supporting to develop an application and a data format procuring method with using said system therein, comprising a definition module of data format transformation for producing an entry data format from a business data format.

Also, according to the present invention, there are provided a system for supporting to develop an application having an entry screen for inputting data, and a data format producing method using the said system therein, comprising: a definition module of data format transformation, for producing a format of entry data to be used by said entry screen from a format of business data, which is targeted by a business program for processing the entry data inputted from said entry screen, and further for producing a format transformation definition for producing said business data from said entry data; a definition module of entry screen, for defining the entry screen for inputting data within an input data format, which is produced in said definition module of data format transformation; and a definition module of relationship of format transformation, receiving the entry screen definition, which is defined in said definition module of entry screen, and the format transformation definition, which is produced in said definition module of data format transformation, for producing a definition of format transformation with data entry screen ID, having an ID for identifying said definition of entry screen, uniquely.

Also, according to the present invention, in the development supporting system for an application having an entry screen for inputting data, and the data format producing method using the said system therein, as described in the above, said definition module of data format transformation has: a first determination process portion for determining on whether a tag be a target of data input or not, with respect to said business data format described in XML; and a tag process portion for processing the tag determined to be the target of data input in said first determination process portion, so that said tag be remained, while processing the tag determined not to be the target of data input in said first determination process portion, so that said tag be deleted, if child tags below a hierarchy can be distinguished, separately, when deleting that hierarchy of said tag.

Also, according to the present invention, in the development supporting system for an application having an entry screen for inputting data, and the data format producing method using the said system therein, as described in the above, said definition module of data format transformation has: a first determination process portion for determining on whether a tag be a target of data input or not, with respect to said business data format described in XML; a second determination process portion for determining on whether names of child tags below a hierarchy are duplicated or not when deleting that hierarchy of said tag, upon the tag determined not to be the target of data input in said first determination process portion; and a tag process portion for processing the tag determined to be the target of data input in said first determination process portion, so that said tag be remained, and processing the tag determined to be duplicated in said second determination process portion, so that said tag be deleted, or a name of said tag be added before the name of the child tag, while processing the tag determined not to be duplicated in said second determination process portion, so that said tag be deleted.

And also, according to the present invention, in the development supporting system for an application having an entry screen for inputting data, and the data format producing method using the said system therein, as described in the above, said second determination process portion has a portion for determining on whether the names of the child tags below the hierarchy are duplicated or not, within same structure, on the hierarchy of the tag determined not to be said target of data input, and a portion for determining on whether the names of the child tags below the hierarchy are duplicated or not, within different structures, on the hierarchy of the tag determined not to be said target of data input.

Further, according to the present invention, there is also provided a data processing system, receiving data attached with a data entry screen ID, which is inputted and transmitted through an entry screen of a client, for producing business data depending upon said entry screen, thereby providing the said business data produced to a business module, to be executed, having a format transformation module therein, for achieving format transformation, which is determined for each of the entry screens, upon a format transformation call of a reception module.

Also, according to the present invention, there is further provided a data processing system; receiving data attached with a data entry screen ID, which is inputted and transmitted through an entry screen of a client, for producing business data depending upon said entry screen, thereby providing the said business data produced to a business module, to be executed, comprising: a managing database of entry screen definition for managing various kinds of definitions of entry screens, each defining validation item for an input column on each entry screen, and various kinds of format transformation definitions with data entry screen IDs, corresponding to various kinds of data entry screen IDs; a reception module for receiving entry data attached with the data entry screen ID transmitted from the entry screen of the client; an entry data validation module for selecting a definition of entry screen, corresponding to the data entry screen ID received within said reception module, from various kinds of definitions of entry screens managed within said managing database of entry screen definition, thereby validating the entry data received in said reception module upon basis of said selected definition of entry screen; and a format transformation module for selecting a definition of format transformation, corresponding to the data entry screen ID validated within said entry data validation module, from various kinds of format transformation definitions with data entry screen IDs, which are managed within said managing database of entry screen definition, thereby transforming the entry data validated within said entry data validation module, upon basis of said definition of format transformation selected, whereby the business data transformed by said format transformation module is provided to the business module.

Further, according to the present invention, in the data processing system, as described in the above, the definition of format transformation is a definition for transforming from an entry data format having a simple hierarchical structure into a business data format having multi-layer hierarchical structure added with a necessary tag, in said format transformation module.

Thus, according to the present invention, there can be obtained an effect of reducing the number of steps of developments and maintenance steps for the entry screen and the data receiving programs, in particular, within the applications having the entry screen therein.

Also, according to the present invention, there can be obtained the data processing system, for making transformation from the entry data attached with data entry screen ID, which is inputted and transmitted through the entry screen of the client, into the business data using the definition of format transformation with data entry screen ID, thereby proving it to the business module.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an entire view for showing the configuration of an embodiment of a development supporting system of an application having an entry screen for inputting data, according to the present invention;

FIG. 2 is a view for explaining an install screen of a definition module of data format transformation shown in FIG. 1, and in particular, showing an embodiment of reading a business data format in relation to an ordering business within a window on the left-hand side;

FIG. 3 is a view for explaining an embodiment of the install screen of the definition module of data format transformation shown in FIG. 1, and in particular, showing an embodiment of reading a business data format in relation to the ordering business within a window on the left-hand side, while showing an embodiment of an entry data format, which is produced from the business data in relation to the ordering business, within a window on the right-hand side;

FIG. 4 shows XML for showing an embodiment of a format of the business data in relation to the ordering business, according to the present invention;

FIG. 5 is a view for showing an embodiment of an input data format, which is produced from the business data in relation to the ordering business, according to the present invention;

FIG. 6 is a flowchart for showing an embodiment of a transformation process of data format, applying the definition module of data format transformation shown in FIG. 1, therein;

FIG. 7 is a view for showing an embodiment of a format transformation definition for producing the business data from the input or entry data, according to the present invention;

FIG. 8 is a view for showing an embodiment of a processing flow for producing the format transformation definition, with using the definition module of data format transformation shown in FIG. 1;

FIG. 9 is an explanatory view for showing an embodiment of the install screen of the definition module of data format transformation shown in FIG. 1;

FIG. 10 is an explanatory view for showing an embodiment of an install screen of a definition module of relationship of format transformation shown in FIG. 1;

FIG. 11 is a system structure view for showing an embodiment of an application data processing system, utilizing a definition of data format transformation with data entry screen ID, according to the present invention;

FIG. 12 is a view for showing an embodiment of a format of a table, being managed by a database of entry screen definition, which builds up the application data processing system shown in FIG. 11;

FIG. 13 is a flowchart for showing an embodiment of the data reception program within a server shown in FIG. 11;

FIG. 14 is a view for showing an embodiment of display of entry data, which are inputted from a client with using an entry screen, in relation to an application business for a commuting allowance or compensation, according to the present invention;

FIG. 15 is a view for showing an embodiment of an entry data format, in relation to an application business for the commuting allowance or compensation, according to the present invention; and

FIG. 16 is a view for showing an embodiment of a business data format, in relation to an application business for the commuting allowance or compensation, according to the present invention.

### DETAILED DESCRIPTION OF THE INVENTION

Hereinafter, the best mode for practicing the present invention will be fully explained by referring to the attached drawings.

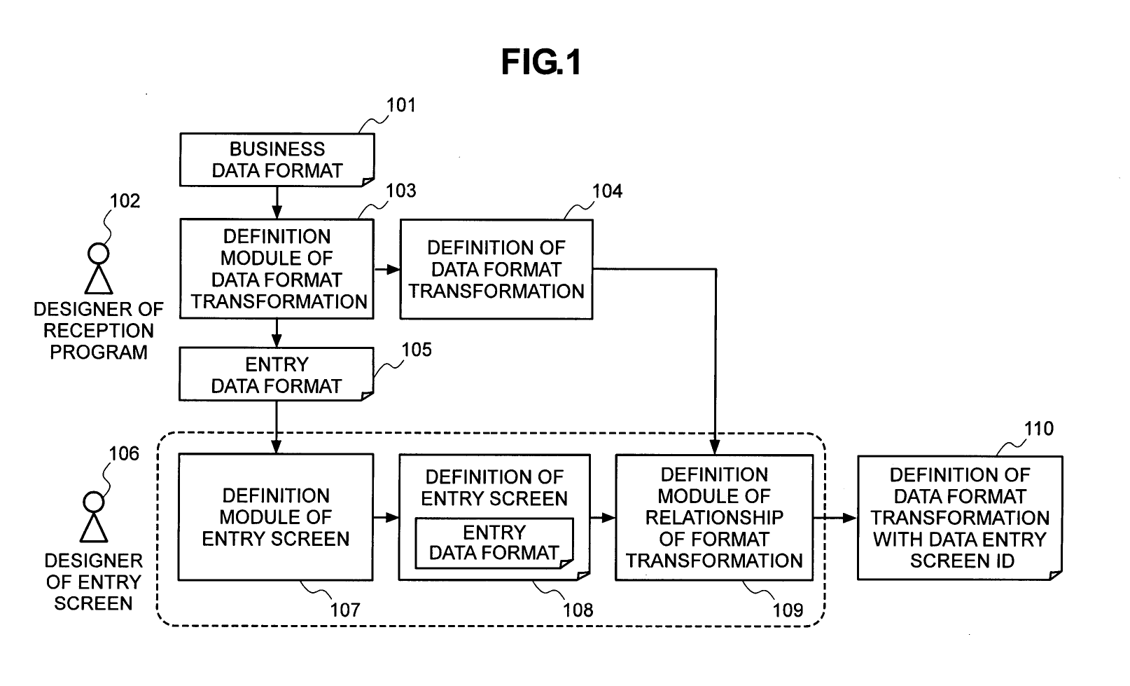

First of all, explanation will be given about a development supporting system (i.e., a data format producing system) for an application and a method thereof, in particular, in designing and/or developments, etc., for achieving the data format producing method, as being a designing technology for a computer system, accompanying an entry screen of data, according to the present invention, by referring to FIGS. 1 to 10.

FIG. 1 shows a total structure view of an embodiment of the application development supporting system (i.e., the data format producing system), in designing and/or developing, etc., for achieving the data definition method (i.e., a data format producing method), according to the present invention.

As is shown in FIG. 1, the development supporting system of an application, for accomplishing the present invention, comprises a definition module of data format transformation 103, a definition module of entry screen 107, a definition module of relationship of format transformation 109.

The definition module of data format transformation 103, being used by a designer 102 in charge of a data receipt program, inputs business data format 101, and outputs an entry data format 105 and a definition of format transformation 104, as being a transformation definition between the business data format 101 and the entry data format 105.

The definition module of entry screen 107, being used by a designer 106 in charge of an entry screen, inputs the entry data format 105, and outputs a definition of entry screen 108. Within the entry screen 108 is included the entry data format 105.

The definition module of relationship of format transformation 109, being used by the designer 106 in charge of an entry screen, inputs the definition of format transformation 104 and the definition of entry screen 108, and outputs a definition of data format transformation with data entry screen ID 110.

Hereinafter, explanation will be made about each module, in details thereof.

First, explanation will be made about the definition module of data format transformation 103.

The definition module of data format transformation 103 inputs the business data format 101, and outputs the entry data format 105 and the definition of format transformation 104 between the business data format 101 and the entry data format 105.

Herein, the business data format 101 means the structure of data, which is defined for each of business processes or businesses, such as, calculation, tantalization, registration, etc. For example, it is defined by a format, such as, ebXML and JEDICOS XML, in a business field of distribution, and by a format XBRL or the like, and XML, in a business filed of finance.

Next, an embodiment will be shown of the data format, which is described with using the XML mentioned above.

<Ordering Company>

<Company Name> ◯? Company, Ltd.</Company Name>
<Telephone Number>123456789</Telephone Number>

</Ordering Company>

Herein, a string or a line of characters, which is surrounded by “<” and “>”, or “</” and “>”, is called by a “tag”. The tag starting with “<” is called by a “start tag”, while the starting with “</” is called by an “end tag”. And, the character string or line surrounded by “<” and “>” and that surrounded by “</” and “>”, being same to each other, are considered to be one (1) set or a pair of tags, and the character strings surrounded by the set of tags are considered to be data corresponding to the tags. In this example, “◯? Company, Ltd.” is the data corresponding to the company name, and “123456789” is the data corresponding to the telephone number. Also, with XML, it is possible to define a hierarchy structure; i.e., the entire of <Company Name> ◯? Company, Ltd.</Company Name> and <Telephone Number>123456789</Telephone Number> make up the data corresponding to the ordering company.

The XML is a metha language, with which a format of data can be defined, in this manner, and the definition of this metha language is a recommendation of W3C (http://www.w3.org/XML).

There is also a specification, XSLT (extensible Stylesheet Language), deeply relating to the XML mentioned above. This is the specification for transforming a document described with using the XSLT into other format, and is also a recommendation of W3C (http://www.w3.org/XSL). Among other formats, there is also included the XML, and therefore, it can be used for transformation of the data format, which is described with using the XML.

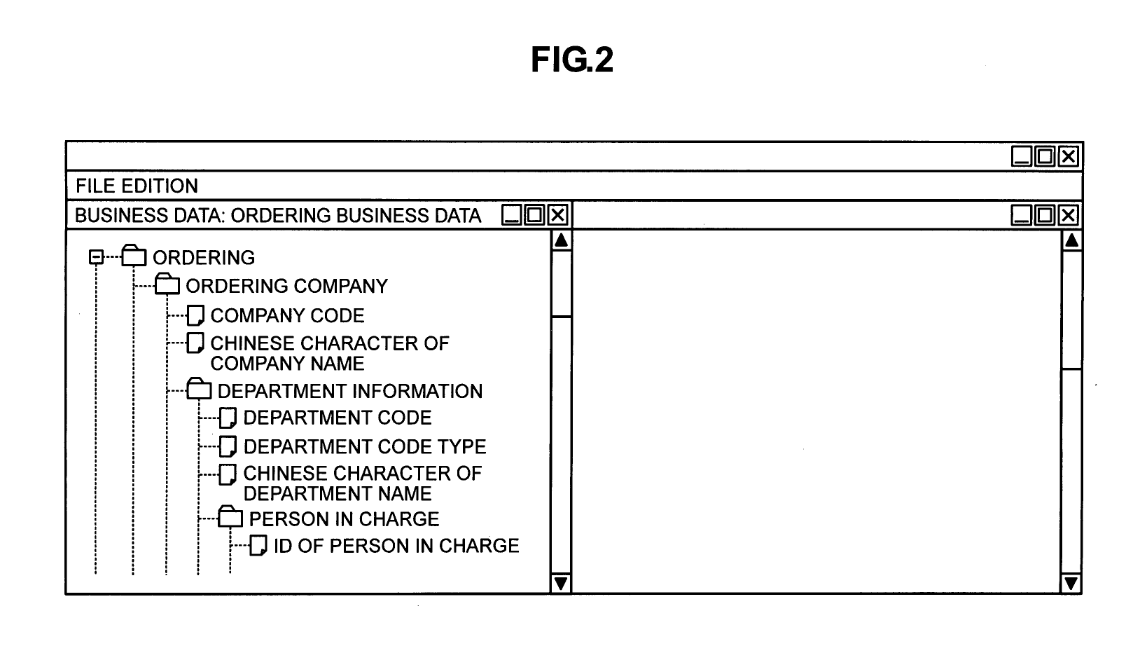

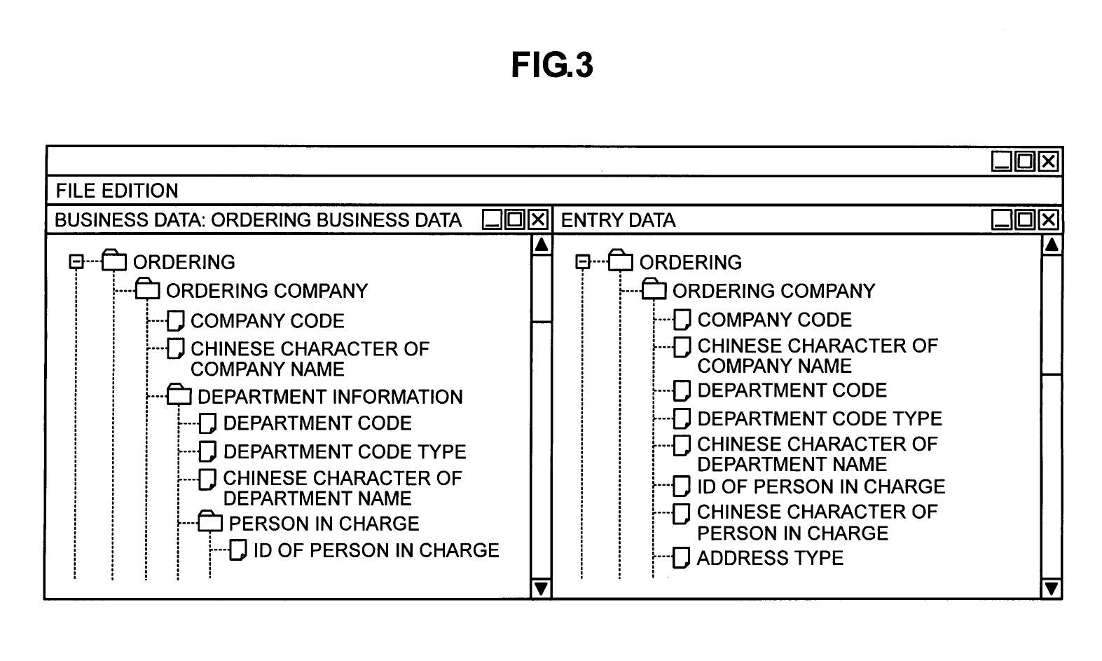

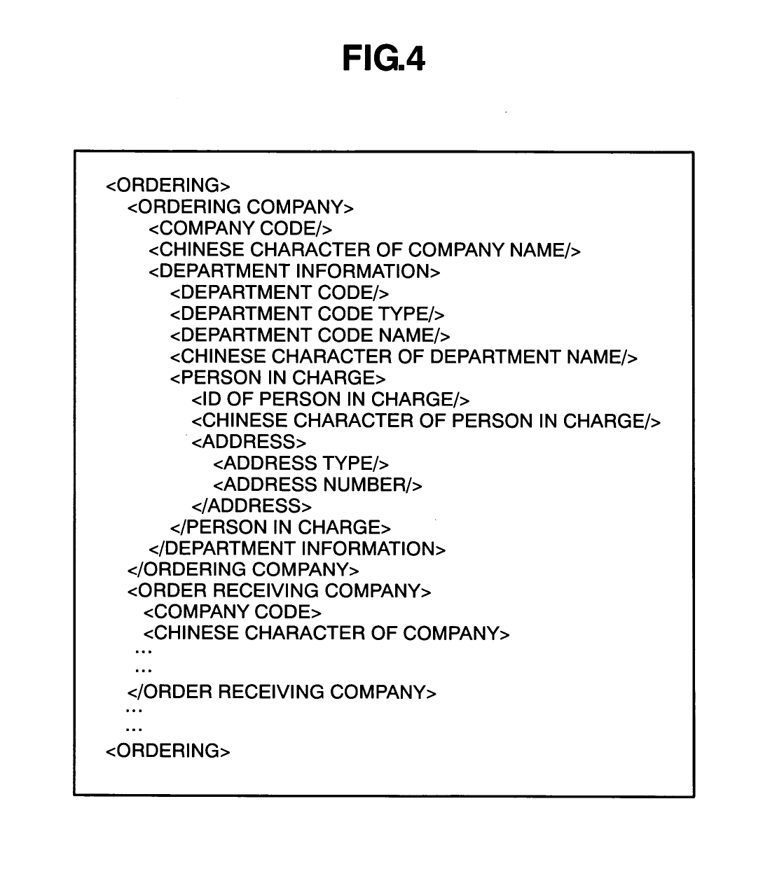

In this manner, the business data format 101 comes to have such the data structure as is shown within a window on the left-hand side in FIGS. 2 and 3 and in FIG. 4. Further, the business data format 101 is defined, normally, irrelevant to an entry screen, and has the complicated data structure; therefore, it is difficult to design the entry screen.

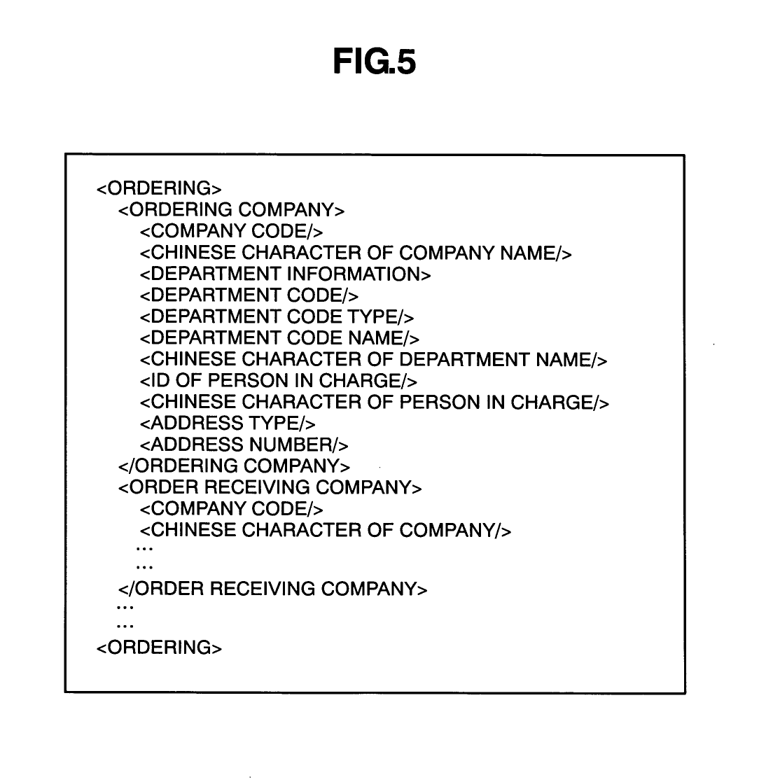

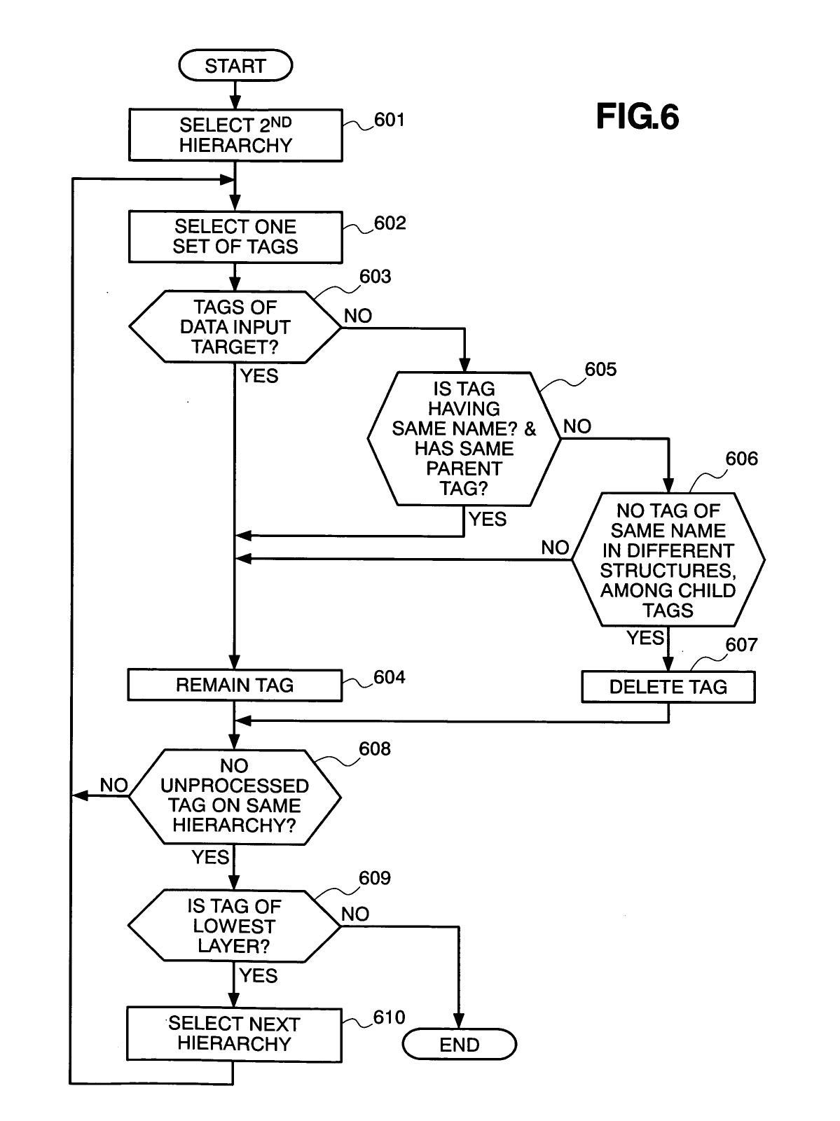

Then, it is necessary to make transformation in accordance with a process flow shown in FIG. 6, with applying the definition module of data format transformation 103 into the entry data format 105 having a simple data structure (i.e., the minimum and necessary hierarchy structure). Within the window on the right-hand side in FIG. 3 and in FIG. 5, there is shown the entry data format 105 having the simple data structure (i.e., the minimum and necessary hierarchy structure), which is produced in case of an ordering business.

And, the entry data format 105 is also a format of the data having a simple data structure, which are inputted by a user of an application through a screen on Web. However, the entry data format 105 must be designed or developed, separately, for each the entry screen. As a result of this, for the designer 106 in charge of the entry screen, by making correspondence between each element of the entry data format 105 and a data entry part disposed on an entry screen, with using the definition module of entry screen 107, it is possible to design the entry screen, easily.

FIG. 2 shows an embodiment, the business data format relating to the ordering business is read into the definition module of relationship of format transformation 109. Thus, the business data format 101 is displayed at the time-point when reading it, in a form of the directory structure, within the window on the left-hand side shown in FIG. 2. However, at the time-point when reading the business data format, since the entry data is not produced, yet, therefore, the window on the right-hand side shown in FIG. 2 is not displayed.

Within the window on the left-hand side shown in FIG. 3, there is shown the directory structure of the business data format 101, which is read therein, while within the window on the right-hand side is shown the entry data format 105 showing the simple data structure (i.e., the minimum and necessary hierarchy structure), which is produced from the data of ordering business with using the definition module of data format transformation 103.

Within the window on the left-hand side shown in FIG. 2, the hierarchy stricture of the directory corresponds to the hierarchy stricture of the XML. The directory and characters written on the right-hand sides of marks of files correspond to a tag name of the XML. The tag having a child tag therein is indicated in the form of directory, while the tag having no child tag in the form a file.

When selecting a specific directory within the ordering business data, and further when selecting “Produce Entry Data” in an editing menu, as is shown in FIG. 3, a format of the entry data within the window on the right-hand side. Thus, FIG. 3 shows an example when selecting an ordering directory of the ordering business data, and further when selecting production of the entry data.

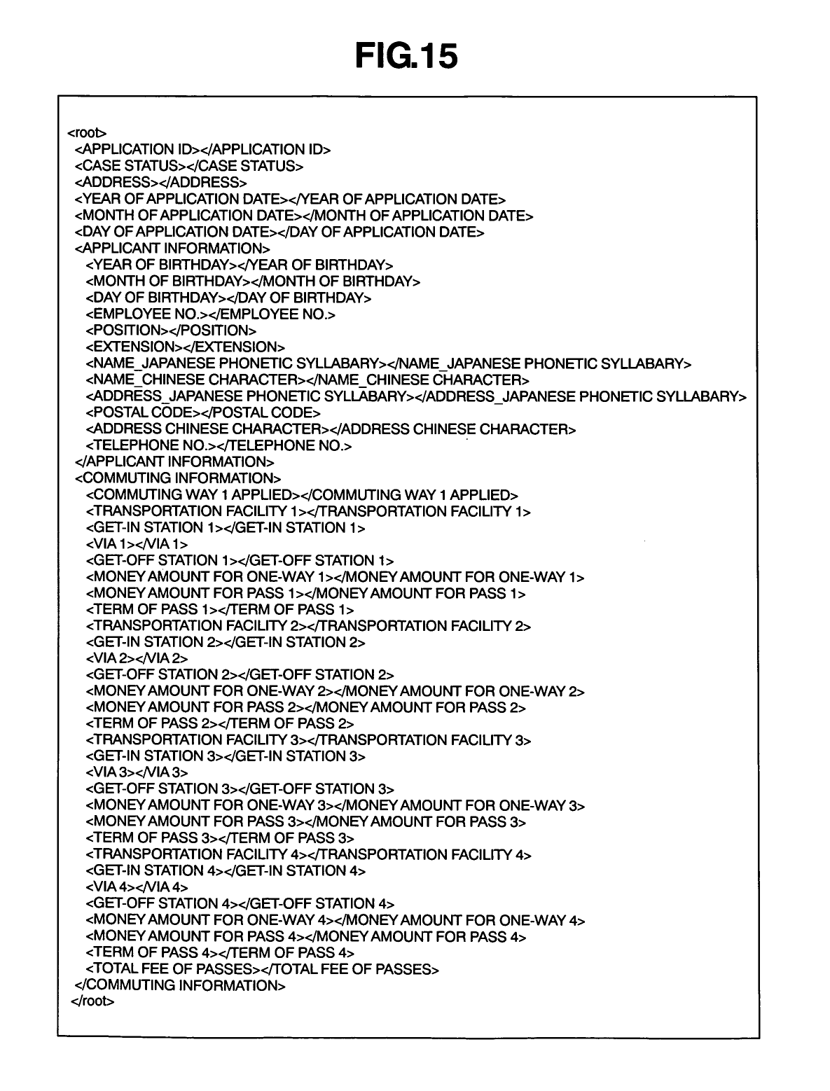

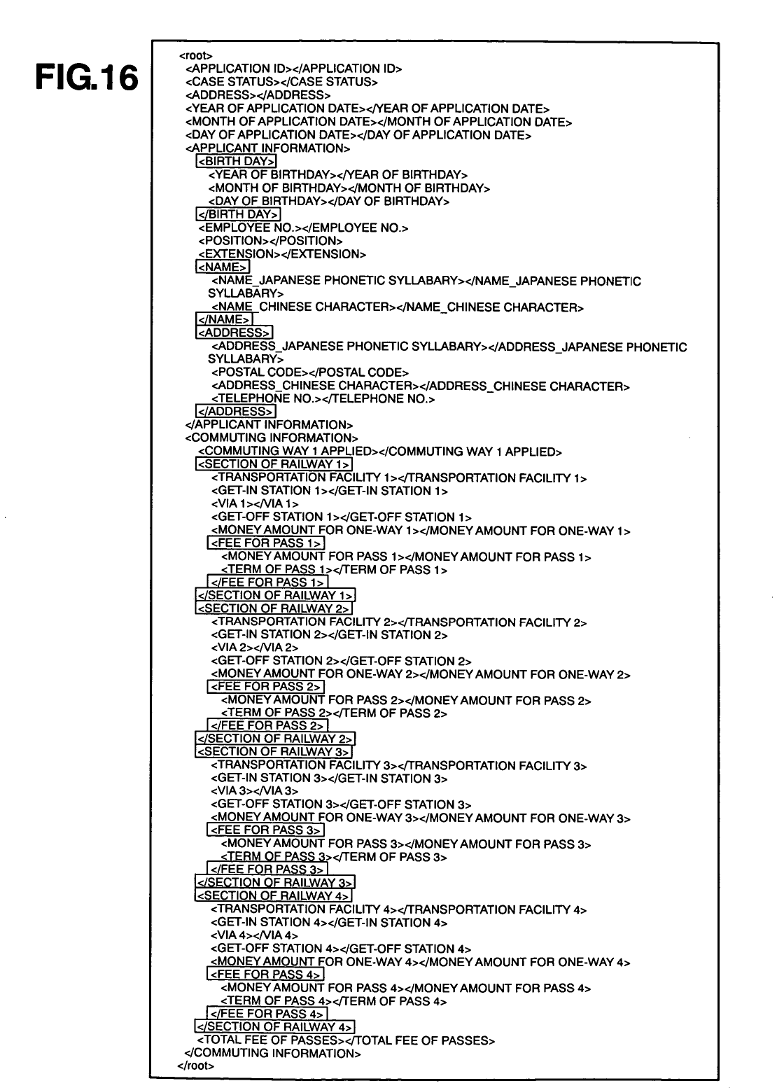

In FIGS. 4 and 16, there is shown a business data format 101, on which it is difficult to design an entry screen having the hierarchy structure of the directory corresponding to the hierarchy structure of the XML. FIG. 4 shows a case of the ordering business, and FIG. 16 shows a case of the application business for commuting allowance or compensation, respectively. In FIG. 16, the tag surrounded by a frame indicates the tag, which is deleted on the entry data format 105 shown in FIG. 15.

FIGS. 5 and 15 show the entry data format 105, which is produced with using definition module of data format transformation 103, in accordance with the process flow shown in FIG. 6, for example; i.e., the entry data format, design on the entry screen of which can be made, easily. FIG. 5 shows the case of the ordering business, and FIG. 15 shows the case of the application business for commuting allowance or compensation, respectively.

When producing the entry data format, an element shown as the directory is deleted. This is because no data is inputted into the element shown in the form of directory with using the entry screen, and therefore, there is no necessity of making correspondence to the data input part when producing the entry screen. Thus, from a viewpoint of producing the entry screen, it is an unnecessary tag. Comparing the windows on both sides shown in FIG. 3, or those shown in FIGS. 4 and 5, deletion is made on the tags having no direct relation to the data entry; such as, a tag of a department, a tag of a person in charge, etc. However, in the case when it is generated in plural numbers thereof under the same structure within the same parent tag, and/or when a child tag is generated with the same name under the different structure within the same parent tag, the tag selected is remained, such as, a tag of the ordering company and a tag of a company, which receives the order, for example.

However, in case of remaining the repetitive structure of data (i.e., when it is generated in plural numbers in the same structure within the same parent tag; thus, when the ordering companies or the order receiving companies are plural in the number thereof) in FIGS. 4 and 5, and also in case where the element tags (i.e., the child tags) below it are duplicated in the name thereof when removing the tag indicative of the hierarchy (i.e., when the child tags having the same name are generated under the different structures within the same parent tag, thus, when the tags of the company code and/or the Chinese character tags of the company name, as the element tags (i.e., the child tag) are plural in the number thereof, in the hierarchy below the tag of the ordering company or the order receiving company in FIGS. 4 and 5.

A reason there remains the tag of the ordering company and/or the order receiving company in FIG. 5 lies in that the tag of the company code and/or the Chinese character tag of the company name is/are below the tag(s) of the ordering company and/or the order receiving company, and therefore, if being removed, the tag(s) of the ordering company and/or the order receiving company are duplicated; i.e., it is impossible to determine on whether it relates to the ordering company or the order receiving company.

For dealing wish such the case, it is determined on whether the tags below a second (2^{nd}) hierarchy should be deleted or not, upon basis of the process flow shown in FIG. 6, with using the definition module of data format transformation 103. However, since the tag(s) on a first (1^{st}) hierarchy is/are necessary for inputting data, therefore it/they must be always remained.

Next, detailed explanation will be given about an example of the process flow for producing the entry data format 105 from the business data format 101, with using the definition module of data format transformation 10, by referring to FIG. 6.

First, since the tag of the first (1^{st}) hierarchy must be always remained, then the second (2^{nd}) hierarchy is selected for starting from that second (2^{nd}) hierarchy (a processing step 601). Next, from among the hierarchies selected, a one (1) set of the tags is selected (a processing step 602). Then, it is determined on whether the selected one (1) set of the tags is that of a data input target or not (a processing step 603). In case if it is the set of tags of the input target, a process advances into a processing step 604. If not so (i.e., when it is the tag of the ordering company, the tag of the order receiving company, the tag of the department information, the tag of the person in charge, etc., in FIG. 4, for example), the process advances into a processing step 605. Within the processing step 604, the one (1) set of tags selected is remained (i.e., not delete it).

In the processing step 605, it is determined on whether there is a tag or not, having the same name and further the same parent tag to that of the selected one (1) set of tags. If there is (i.e., when the tags of ordering company are plural in the number thereof, having the same name, within the one (1) set of the ordering tags, as being the same parent tag, from among the business data shown in FIG. 4), there is a necessity of inputting data so as to determine the ordering company, respectively, and then the process advances into the processing step 604 for remaining the selected one (1) set of the tags of the ordering companies. If not (i.e., when the tag of the ordering company is only one (1) among the business data shown in FIG. 4), then the process advances into a processing step 606.

In the processing step 606, determination is made on whether there is the tag of the same name or not, within the different structures (i.e., the ordering company and the order receiving company, in the business data shown in FIG. 4, for example), for all of the child tags of the selected one (1) set of tags. If there is not, the process advances into a processing step 607, on the other hand if there is, then it advances into the processing step 604. Herein, among the business data shown in FIG. 4, the tag of the company code and/or the tag of the company name correspond(s) to “the tags of the same name within the different structures (i.e., the ordering company and the order receiving company, in the business data shown in FIG. 4, for example), for all of the child tags of the selected one (1) set of tags”, and therefore, it is determined that there is. The tag of the company code and/or the tag of the company name is/are included in each of the ordering companies giving an order and the order receiving companies receiving the order, being different in the structures, and both of them necessitate inputting of data, to discriminate between the ordering company and the order receiving company; therefore, the tag of the ordering company and the tag of the order receiving company are remained.

As was explained in the above, the tag indicative of the hierarchy is remained, in the case where the elements are duplicated in the name thereof if removing the tag and the hierarchy of the data input target, so as to determine the element.

In the processing step 607, in anyway, there is no need of inputting of data, or no need of division thereof, so as to enable the determination; therefore, the selected one (1) set of tags is deleted.

Next, in a processing step 608, it is determined on the presence of an unprocessed set of tags within the same hierarchy as the selected one (1) set of tags. If there is, the process turns back to, thereby to be executed from the processing step 602, again. If not, the process advances into a processing step 609.

In the processing step 609, it is determined on whether the selected one (1) set of tags is a one (1) set of tags of the lowest hierarchy or not. If it is not the one (1) set of tags of the lowest hierarchy, the process advances into a processing step 610. On the other hand, if it is the one (1) set of tags of the lowest hierarchy, the process for producing the entry data format is ended.

However, there may be a case where execution is made after changing in the embodiment mentioned above, as will be mentioned below. Thus, in case where a result is “No” of the determination made within the processing step 606 shown in FIG. 6, then the process for deleting the selected one (1) set of tags is executed, but without executing the process for remaining the one (1) set of tags selected within the processing step 604, after adding a name of the selected one (1) set of tags before the name of the child tag thereof. In the case of the business data shown in FIG. 4, before the name of the child tag of <Ordering Company> is added the ordering company, i.e., <Ordering Company/Company Code/>, <Ordering Company/Chinese Characters of Company Name/>. . . , and <Ordering Company></Ordering Company> is deleted; while, the order receiving company is added before the name of the child tag of <Order Receiving Company>, i.e., <Order Receiving Company/Company Code>, <Chinese Characters of Company Name/>. . . , and<Order Receiving Company></Order Receiving Company > is deleted.

As was explained in the above, deletion is made upon the input of data, i.e., the tags having no relationship to the design of the entry screen, and thereby producing the entry data format 105, which has such a simple structure, as is shown in FIG. 5, for example.

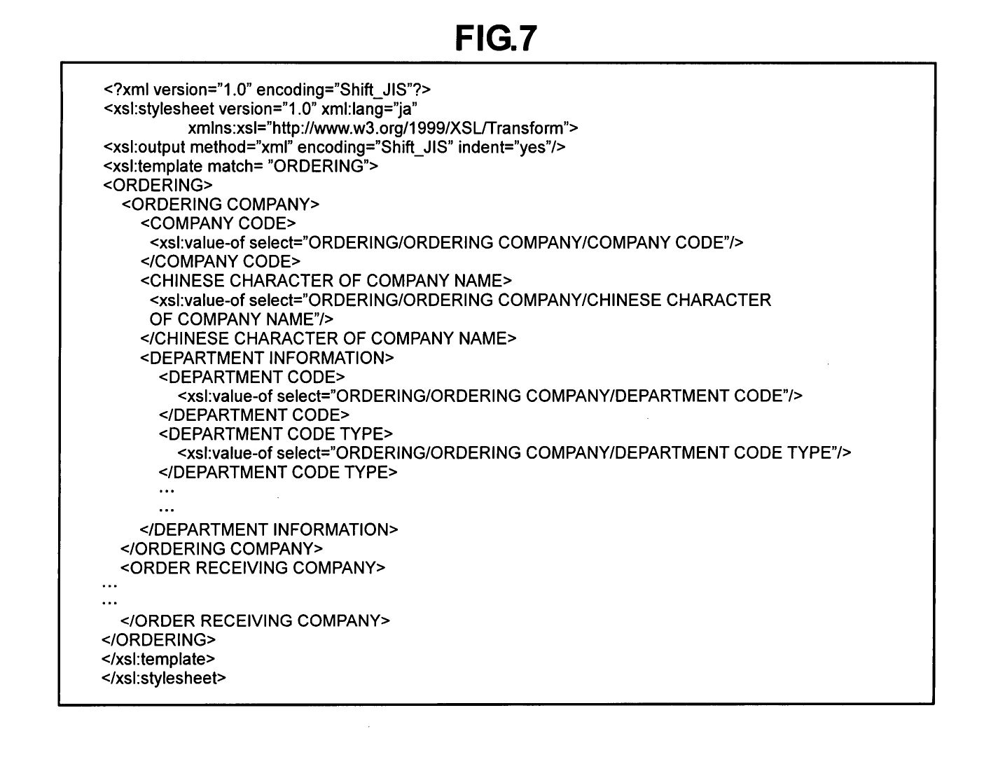

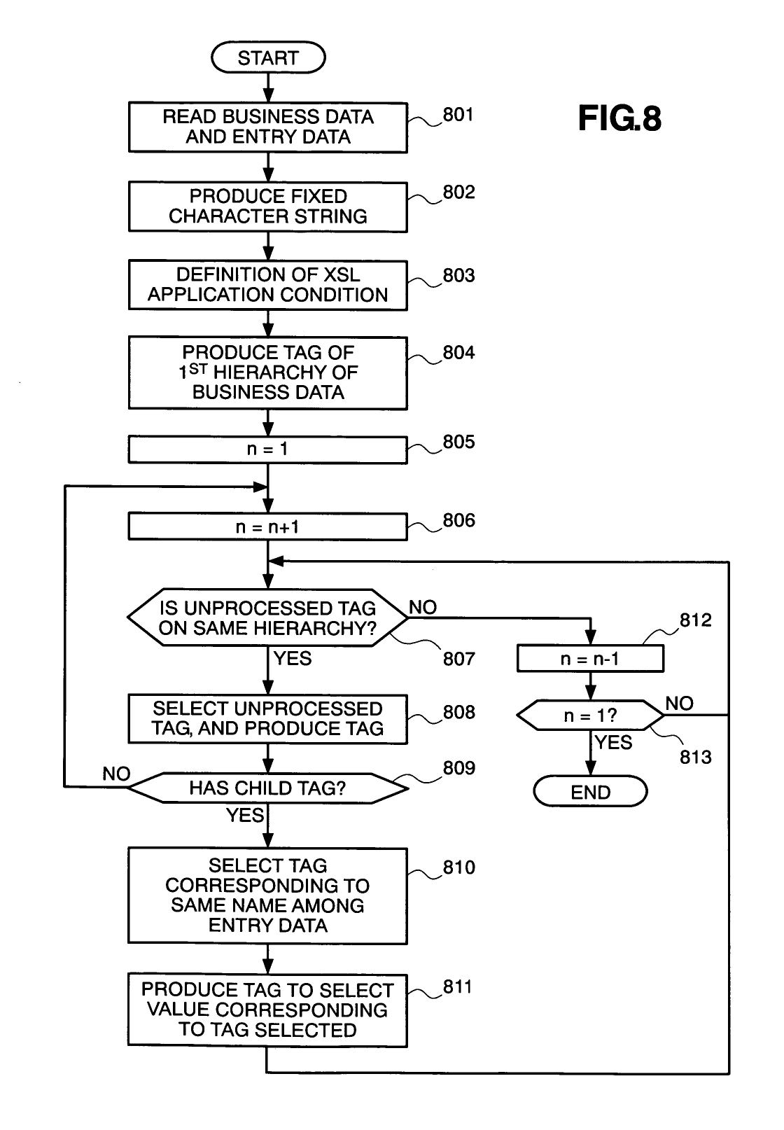

Next, explanation will be given about an embodiment for producing the definition of format transformation 104, upon basis of the business data format 101 and the entry data format 105 transformed, with using the definition module of data format transformation 103, by referring to FIGS. 7 and 8.

FIG. 7 shows an embodiment of the definition of format transformation 104. Herein, the definition of format transformation is a definition for transforming the entry data format 105 into the business data format 101, and it is described with using the XSLT (extensible Stylesheet Language).

FIG. 8 shows the process flow for producing the definition of format transformation 104 with using the definition module of data format transformation 103. First, in a processing step 801, the business data and the entry data are read into. Next, within a processing step 802, there is produced a common string or a line of fixed characters, within the definition of format transformation 104. In FIG. 7, it is a portion starting from the tag, <?xml version=“1.0”, encoding=“Shift_JIS” ?>, up to <xsl:output method=“xml” encoding=“Shift_JIS ” indent=“yes”/>. In this portion, there are designated the versions of the XML and the XSLT, etc., which are used therein.

In a processing step 803, there is designated a tag name for applying the XSLT. This is a name of the directory, which is selected as a target of transformation in FIG. 2. Herein, “Ordering” is selected.

In a processing step 804 is produced a one (1) set of the start tag and the end tag, having the name determined within the processing step 803. All of the tags, which will be produced within processing steps 805 and thereafter, are added between that start tag and that end tag.

First, in a processing step 805, n=1 is set up. This selects the first hierarchy. Next, in a processing step 806, n is set to n=n+1, thereby selecting the hierarchy, which is further deeper than that by one (1). In the present embodiment, when executing the processing step 806 first, the second hierarchy is selected, i.e., the tags of the ordering companies.

Next, in a processing step 807, confirmation is made upon presence of the unprocessed tag within the hierarchy selected. In the present embodiment, when executing the processing step 807 first, since there is the tag of the ordering company, therefore, it is determined to be “yes”. In this manner, if “yes” within the processing step 807, then a processing step 808 is executed, while if “no”, a processing step 812 be executed.

In the processing step 808, selection is made on the unprocessed tag, and a tag having the same name is produced. In case if executing the processing step 808 first, then the start tag and the end tag of the ordering company are produced.

Next, in the processing step 809, confirmation is made upon the tag, which is selected within the processing step 808, on whether it has a child tag or not. If it has the child tag, a processing step 810 is executed, on the other hand if not, the process turns back to the processing step 806. In the present embodiment, if executing the processing step 809 first, since there is the company code as being the child tag of the ordering company, the confirmation results into “no”, and therefore the process turns back to the processing step 806. If executing the processing step 809, again, after executing the processing steps 807 and 808, in this instance, since there is no child tag in the company codes, therefore the processing step 810 is executed.

In the processing step 810 and a processing step 811, a tag is produced for the purpose of extracting a value, corresponding to each tag of the business data, from among the entry data. Namely, in the processing step 810, a tag having the same name to that produced in the processing step 808, from among the entry data. If there are tags in plural numbers thereof within the entry data, selection is made upon the tag, having the same name in the parent tag thereof. In the processing step 811, a tag is produced for extracting a value corresponding to the tag selected from the entry data. In the present embodiment, in case when selecting the processing step 811, at first time, then the following tag is produced for extracting the data corresponding to the company codes from among the entry data.

<xsl:value-of-select= Ordering/Ordering Company/Company

Code”/>

After executing the processing step 811, the process turns back to it, so as to execute the processing step 807. In the present embodiment, there is the Chinese character tag of the company name, which has no child tag; therefore, the processing steps 808, 809, 810 and 811 are executed, again.

Thereafter, since the tag of the department information has the child tag, the process turns back to the processing step 806, wherein “n” is set to n=4, and process the tag of the department code.

If executing the processing step 807 after processing of the tag of address, through repetition of the similar processes thereon, since there is no tag unprocessed within the same hierarchy, it results into “no”, then a processing step 812 is executed. In the processing step 812, it turns back by one hierarchy. In the present embodiment, since there is no tag unprocessed, even if it turns back by one hierarchy, therefore the processing step 812 is repeated, and since there is the tag of the order receiving company at the stage when establishing n=2, therefore the processing steps 808, 809, 810 and 811 are repeated.

When executing the processing step 812 after processing all of the tags, which are surrounded by the tags of the order receiving company, then it is established n=1, therefore, a processing step 813 is executed, to be ended.

As was explained in the above, such the definition of format transformation 104 as is shown in FIG. 7, is produced for each of the entry data formats, with using the definition module of data format transformation 103.

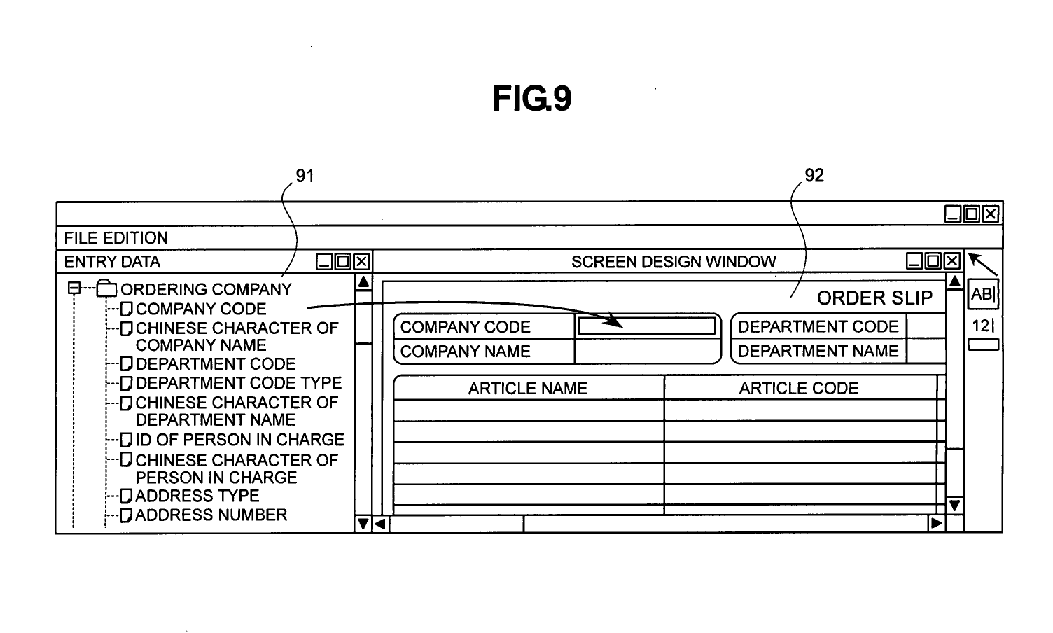

Next, explanation will be made about the definition module of entry screen 107, by referring to FIG. 9. The definition module of entry screen 107 inputting the entry data formats 105, for each, and thereby outputs the definition of entry screen 108 corresponding to each thereof. Thus, the definition of entry screen 108 is provided to the definition module of relationship of format transformation 109, under the condition of being designed and defined for each the entry data format, including the entry data format therein. Within each the definition of entry screen 108 is included each the entry data format 105. FIG. 9 shows an embodiment of designing a predetermined order entry screen, by reading the predetermined order entry data into the definition module of entry screen 107. As is shown in FIG. 9, the definition module of entry screen is built up with a window 91 for displaying the entry data thereon, and a screen-designing window 92.

For example, while picking up the text entry part, which is described in “AB|”, from a tool bar displayed on the right-hand side end of the screen, and when the company code within the input data window 91 is dragged & dropped into the screen-designing window 92, as is shown in FIG. 9, then the text entry part (i.e., being made up with an article name, and article code, etc.) is disposed in such a form that it is corresponded to the company code.

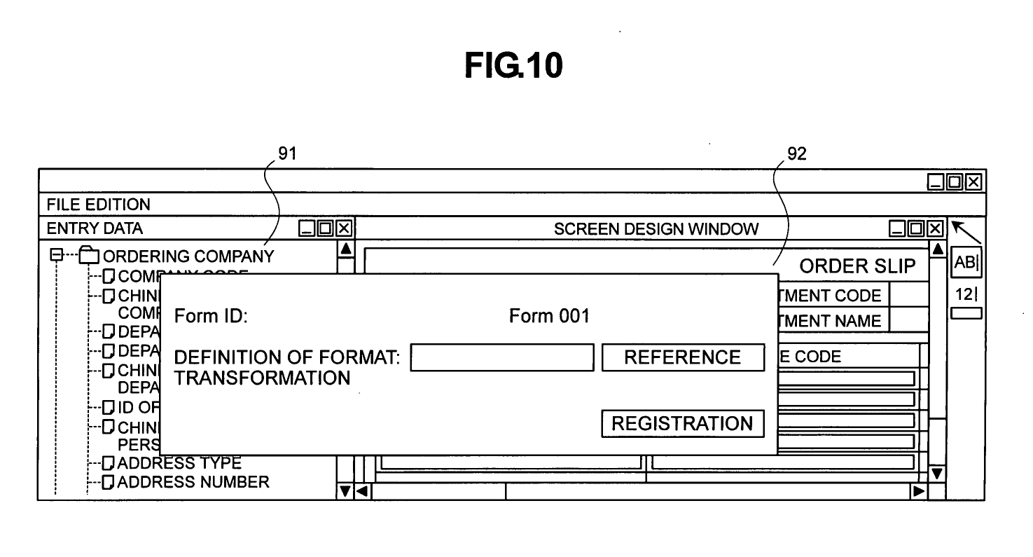

Next, explanation will be made about the definition module of relationship of format transformation 109, by referring to FIG. 10. The definition module of relationship of format transformation 109 inputs the definition of entry screen 108 which is designed and defined with using the definition module of entry screen 107, and the definition of format transformation 104 which is defined with using the definition module of data format transformation 103, and then outputs the definition of data format transformation with data entry screen ID 110. The definition of data format transformation with data entry screen ID 110 is obtained from definition of format transformation 104, by adding an identification ID, i.e., indicating to which definition of entry screen the said definition of transformation relates to, into the definition of format transformation 104. In more details thereof, “Form ID” included within the definition of the entry screen is added into the definition of format transformation 104 shown in FIG. 7.

FIG. 10 shows a screen image of the definition module of relationship of format transformation 109. In FIG. 10, there is shown a dialog, which is displayed when selecting the definition of relationship of format transformation, from the file menu displayed on the definition module of entry screen 107. In FIG. 10, “Form ID” is an ID for identifying an entry screen, uniquely. Thus, while designating the definition of format transformation, which is produced in advance, on the present dialog, a click on a registration button starts a production of the definition of data format transformation with data entry screen ID 110.

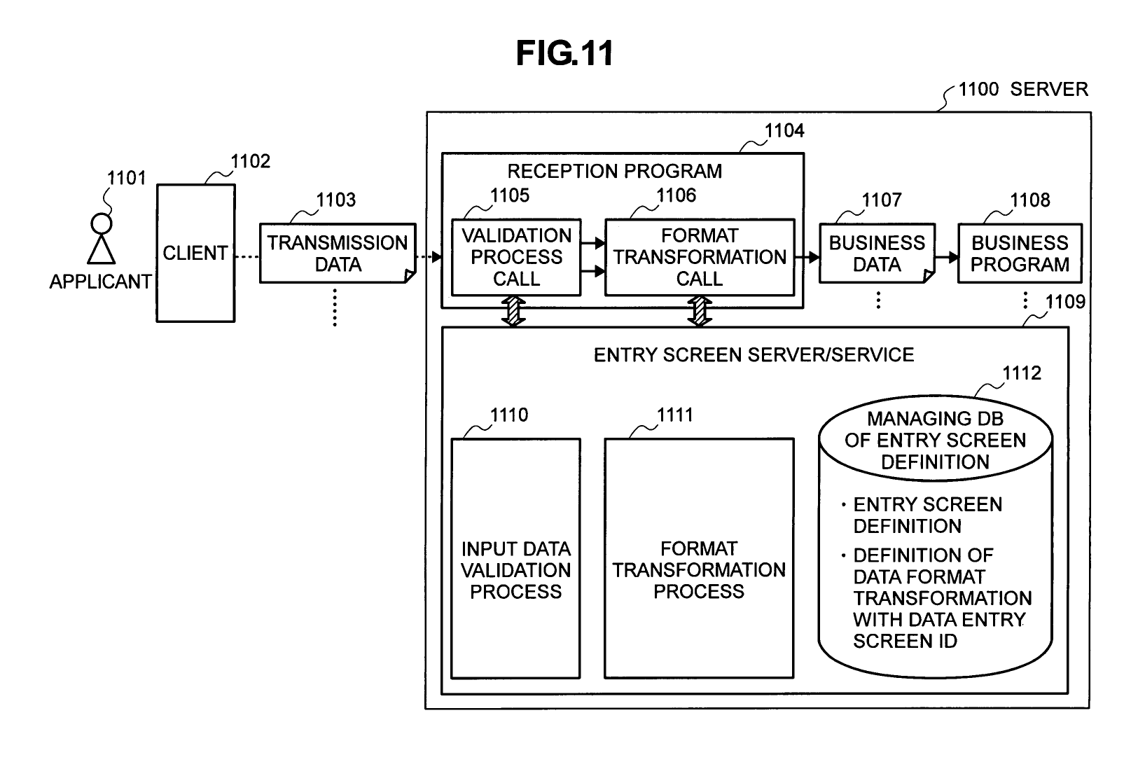

Next, explanation will be made about an embodiment of an application system (i.e., a data processing system) utilizing the definition of data format transformation with data entry screen ID, by referring to FIGS. 11 to 13.

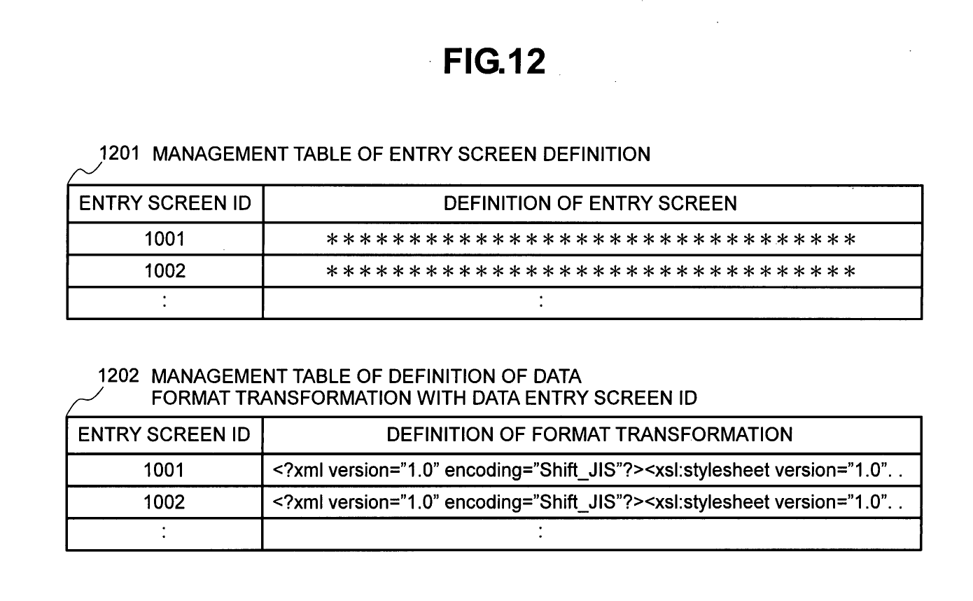

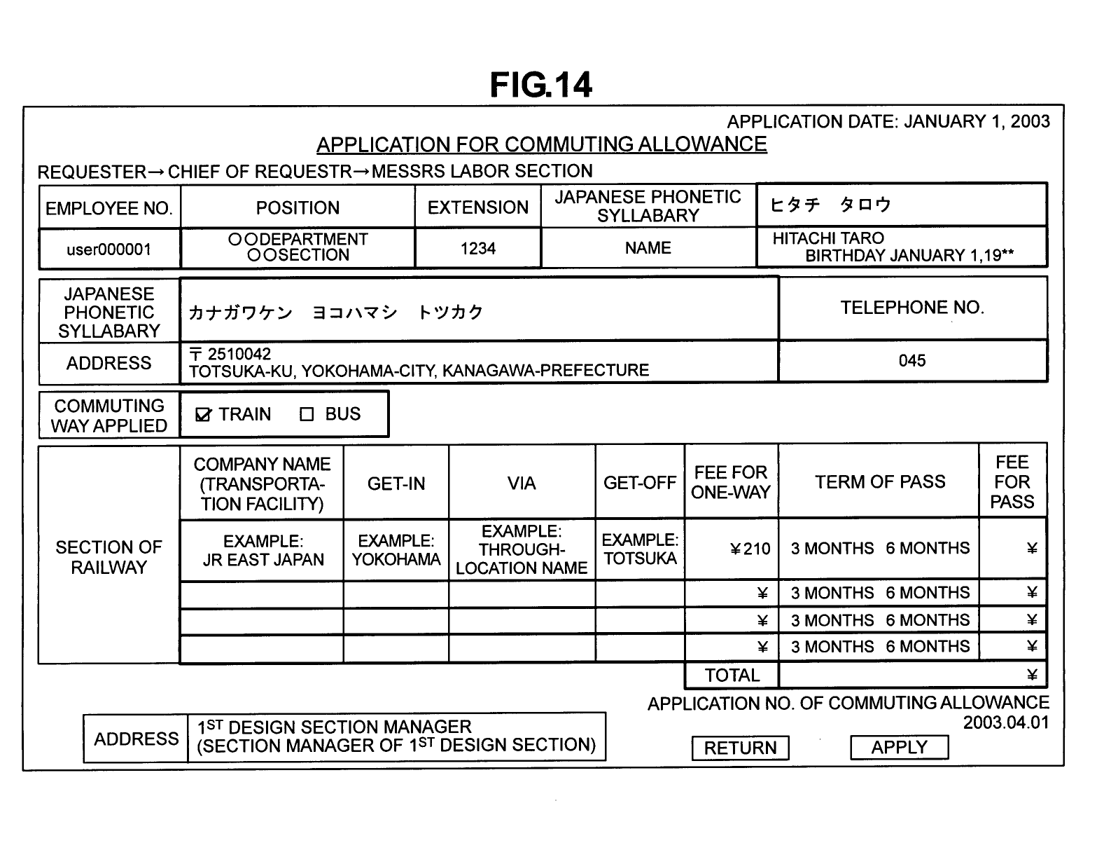

FIG. 11 shows the structure of an embodiment of the application system (i.e., the data processing system). In the system shown in FIG. 11, an applicant 1101 inputs data through the entry screen (for example, being the entry screen shown in FIG. 14, when making an application for the commuting allowance or compensation), which is displayed on a client 1102, and send transmission data 1103 inputted, to a server 1100. Within the said transmission data 1103, there are included the data entry screen ID for identifying the entry screen and the entry data. In that instance, it is also possible to select a management table of entry screen definition 1201 shown in FIG. 12, which is accumulated within a managing database (DB) of entry screen definition 1112 of the server 1100, on a screen of the client 1102, thereby to select the entry screen. In the server 1100, a reception program 1104 receives the transmission data 1103, and thereby executing a validation process call 1105. The validation process call 1105 executes an input data validation process 1110 upon an entry screen server/service 1109. Within the input data validation process 1110, validation is made on whether the entry data satisfies or not, restricting conditions, which are defined when defining the definition of entry screen; i.e., the maximum character number for each of input items, values (for example, an amount of money of an order and/or a quantity of an order, in the case of ordering business, etc., or an amount of money of a one-way ticket and/or fee or term of a pass when making the application for the commuting allowance or compensation, etc.), and/or a classification of characters, etc. Further, the reception program 1104 executes a format transformation process call 1106, when the validation process call 1105 is completed. The format transformation process call 1106 executes a format transformation process 1111 (i.e., searching (or extracting) the definition of entry screen and the definition of format transformation (such as, the restricting conditions, etc.) corresponding to the data entry screen ID, which is identified by referring to a large number of the definitions of data format transformation with data entry screen ID 110 accumulated into the managing DB of entry screen definition 1112, conducting a reverse-transformation upon the entry data format 105 (being shown in FIG. 5 in the case of the ordering business, or in FIG. 15 in the case of the business of application for the commuting allowance or compensation, for example), with using the definition module of entry screen 107, upon basis of the definition of entry screen, which is searched (or extracted), as is shown in FIG. 1, and further executing the searched definition of format transformation depending on the said entry data, with using the definition module of data format transformation 103, upon basis of the reverse-transformed entry data format 105; thereby obtaining the business data as being a result of transformation.), thereby providing business data 1107 (being shown in FIG. 4 in the case of the ordering business, or in FIG. 16 in the case of application of the commuting allowance or compensation, for example. However, the tag surrounded by a frame is added when producing the business data from the entry data.) to a business program 1108. The format transformation process 1111 is executed through conducting the search of the defection of format transformation depending on the entry data corresponding to the data entry screen ID, which is identified by using the relation information of entry screen/format transformation, by referring to a large number of definitions of data format transformation with data entry screen ID, which are accumulated into the managing DB of entry screen definition 1112; thereby, obtaining the business data 1107, as a result of the transformation process.

FIG. 12 shows formats of a large number of information corresponding to the large number of data entry screen IDs, which are accumulated within the managing DB of entry screen definition 1112. In the management table of entry screen definition 1201 are stored a large number of the definitions of entry screens (i.e., the restricting condition, etc.) corresponding to the large number of data entry screen IDs. The management table of entry screen definition 1201 is made up with two (2) columns, i.e., a data entry screen ID and an entry screen definition. The data entry screen ID is determined when defining the entry screen (or, when designing the entry screen), as was mentioned above, and it is an ID for identifying the definition of entry screen, uniquely. Into the column of the entry screen definition are stored substances of the entry screen definition. Into a management table of definition of data format transformation with data entry screen ID 1202 are stored a large number of the format transformation definitions corresponding to the large number of the data entry screen IDs. The management table of definition of data format transformation with data entry screen ID 1202 is made up with two (2) columns; i.e., the data entry screen ID and the format transformation definition. The data entry screen ID is determined when defining the entry screen (or, when designing the entry screen), as was mentioned above, and it is an ID for identifying the definition of entry screen, uniquely. Into the column of the format transformation definition are stored substances of the format transformation. Herein, each of the format transformations is that for transforming the entry data, which is transmitted from the client 1102, into the business data upon basis of the entry screen definition indicated by the data entry screen ID of the same record.

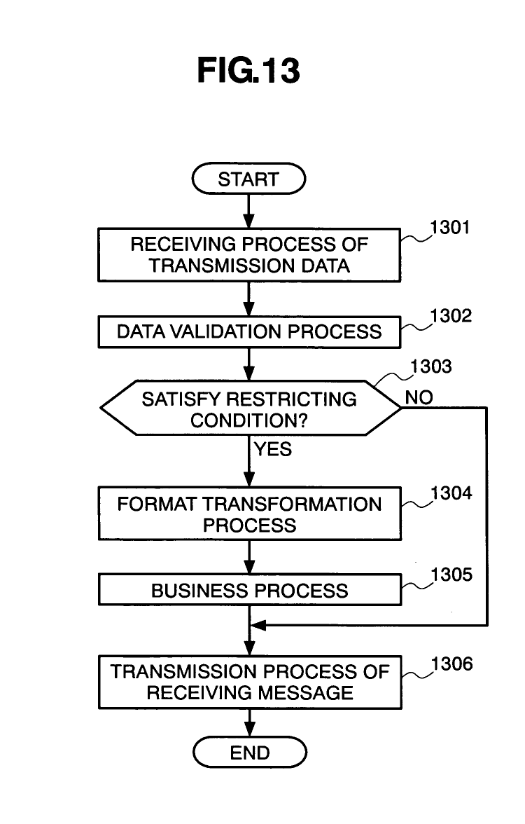

Next, explanation will be made about the process flow of the reception program 1104, etc., within the server 1100, by referring to FIG. 13. Namely, in the processing step of transmission data receiving 1301, the server 1100 receives the transmission data 1103 transmitted from the client 1102, and takes out the entry data and the data entry screen IDs from among the transmission data received. Next, in the processing step of data validation 1302, it calls up the input data validation process 1110 of the entry screen server/service 1109, with using the data entry screen ID and the entry data, which are taken out, as an argument, in accordance with the validation process call program 1105. Within the said called-up input data validation process 1110, the entry screen definition is obtained, by selecting it from the large number of the entry screen definitions accumulated within the management table of entry screen definition 1201, corresponding to the data entry screen ID with using the data entry screen ID as a key, and a validation is made on whether the entry data satisfies restricting condition or not, which is defined in the entry screen definition obtained. Herein, the restricting condition may be the maximum number of characters for each of input items (column) and/or a classification of numerical value/characters, etc. Next, within a processing step 1303, the process is divided upon basis of the result of the processing step of data validation 1302. In case when all the input items (columns) satisfy the restricting condition, a format transformation process 1111 is called up, in accordance with the format transformation process call program 1106, and the process advances into a processing step of format transformation 1304, or otherwise it advances into a processing step of receiving message transmission 1306.

Next, in the processing step of format transformation 1304, the data entry screen ID and the entry data validated are provided to the entry screen server/service 1109, and the format transformation process 1111 is called up. Within the format transformation process 1111 called up, the format transformation definition is obtained, by selecting it from the large number of the format transformation definitions accumulated within the managing DB of entry screen definition 1112, corresponding to the said data entry screen ID with using the data entry screen ID as a key, and the entry data is transformed into the business data 1107 upon basis of the said format transformation definition obtained, to be outputted in accordance with the format transformation process call program 1106.

Next, in a processing step of business 1305 is called up a business module, i. e., a business program, such as, an examination, etc., with using the business data 1107 as an argument, so as to execute the business module, such as, the examination, etc.

Next, in the server 1100, a receiving message is produced upon basis of a result of the business process, such as, the examination, etc., or a result of processing of the data validation process 1302, to be transmitted to client software 1102.

As was explained in the above, according to the embodiment mentioned above, there is provided the data processing system, using the definition of data format transformation with data entry screen ID therein, for receiving the data attached with the data entry screen ID, which is inputted through an input screen of the client and transmitted, so as to produce the business data depending on the said entry screen; thereby, providing the said produced business data to the business module, to be executed.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A system for supporting to develop an application, comprising:
an entry screen for inputting data;
a definition module of data format transformation, for producing a format of entry data to be used by said entry screen from a format of business data, which is targeted by a business program for processing the entry data inputted from said entry screen, and further for producing a format transformation definition for producing said business data from said entry data;
a definition module of entry screen, for defining the entry screen for inputting data within an input data format, which is produced in said definition module of data format transformation; and
a definition module of relationship of format transformation, receiving the entry screen definition, which is defined in said definition module of entry screen, and the format transformation definition, which is produced in said definition module of data format transformation, for producing a definition of format transformation with data entry screen ID, having an ID for identifying said definition of entry screen, uniquely.

2. The system for supporting to develop an application, as described in the claim 1, wherein said definition module of data format transformation has:
a first determination process portion for determining on whether a tag be a target of data input or not, with respect to said business data format described in XML; and
a tag process portion for processing the tag determined to be the target of data input in said first determination process portion, so that said tag be remained, while processing the tag determined not to be the target of data input in said first determination process portion, so that said tag be deleted, if child tags below a hierarchy can be distinguished, separately, when deleting that hierarchy of said tag.

3. The system for supporting to develop an application, as described in the claim 1, wherein said definition module of data format transformation has:
a first determination process portion for determining on whether a tag be a target of data input or not, with respect to said business data format described in XML;
a second determination process portion for determining on whether names of child tags below a hierarchy are duplicated or not when deleting that hierarchy of said tag, upon the tag determined not to be the target of data input in said first determination process portion; and
a tag process portion for processing the tag determined to be the target of data input in said first determination process portion, so that said tag be remained, and processing the tag determined to be duplicated in said second determination process portion, so that said tag be deleted, or a name of said tag be added before the name of the child tag, while processing the tag determined not to be duplicated in said second determination process portion, so that said tag be deleted.

4. The system for supporting to develop an application, as described in the claim 3, wherein said second determination process portion has a portion for determining on whether the names of the child tags below the hierarchy are duplicated or not, within same structure, on the hierarchy of the tag determined not to be said target of data input, and a portion for determining on whether the names of the child tags below the hierarchy are duplicated or not, within different structures, on the hierarchy of the tag determined not to be said target of data input.

5. A data format producing method, using a system for supporting to develop an application having an entry screen for inputting data therein, comprising the following steps of:
a first step for producing a format of entry data to be used by said entry screen, from a format of business data targeted by a business program for processing the entry data inputted from said entry screen, with using a definition module of data format transformation, and further for producing a definition of format transformation for producing said business data from said entry data;
a second step for defining an entry screen for inputting data on the input data format produced in said first step; and
a third step, inputting a definition of entry screen defined in said second step and the definition of format transformation produced in said first step, for procuring a definition of format transformation with data entry screen ID, having an ID for identifying said definition of entry screen, uniquely.

6. The data format producing method, using a system for supporting to develop an application having an entry screen for inputting data therein, wherein said first step has:
a first determination processing step for determining on whether a tag be a target of data input or not, with respect to said business data format described in XML; and
a tag processing step for processing the tag determined to be the target of data input in said first determination processing step, so that said tag be remained, while processing the tag determined not to be the target of data input in said first determination processing step, so that said tag be deleted, if child tags below a hierarchy can be distinguished, separately, when deleting that hierarchy of said tag.

7. The data format producing method, using a system for supporting to develop an application having an entry screen for inputting data therein, wherein said first step has:
a first determination processing step for determining on whether a tag be a target of data input or not, with respect to said business data format described in XML;
a second determination processing step for determining on whether names of child tags below a hierarchy are duplicated or not when deleting that hierarchy of said tag, upon the tag determined not to be the target of data input in said first determination processing step; and
a tag process portion for processing the tag determined to be the target of data input in said first determination processing step, so that said tag be remained, and processing the tag determined to be duplicated in said second determination processing step, so that said tag be deleted, or a name of said tag be added before the name of the child tag, while processing the tag determined not to be duplicated in said second determination processing step, so that said tag be deleted.

8. A data processing system, receiving data attached with a data entry screen ID, which is inputted and transmitted through an entry screen of a client, for producing business data depending upon said entry screen, thereby providing the said business data produced to a business module, to be executed, comprising:
a managing database of entry screen definition for managing various kinds of definitions of entry screens, each defining validation item for an input column on each entry screen, and various kinds of format transformation definitions with data entry screen IDs, corresponding to various kinds of data entry screen IDs;
a reception module for receiving entry data attached with the data entry screen ID transmitted from the entry screen of the client;
an entry data validation module for selecting a definition of entry screen, corresponding to the data entry screen ID received within said reception module, from various kinds of definitions of entry screens managed within said managing database of entry screen definition, thereby validating the entry data received in said reception module upon basis of said selected definition of entry screen; and
a format transformation module for selecting a definition of format transformation, corresponding to the data entry screen ID validated within said entry data validation module, from various kinds of format transformation definitions with data entry screen IDs, which are managed within said managing database of entry screen definition, thereby transforming the entry data validated within said entry data validation module, upon basis of said definition of format transformation selected, whereby the business data transformed by said format transformation module is provided to the business module.

9. The data processing system, as described in the claim 8, wherein the definition of format transformation is a definition for transforming from an entry data format having a simple hierarchical structure into a business data format having multi-layer hierarchical structure added with a necessary tag, in said format transformation module.
